(19) United States
(12) Patent Application Publication
(10) Pub. No.: US 2026/0321442 A1
(43) Pub. Date: Oct. 15, 2026

(54) IMPROVEMENTS IN AND RELATING TO FUSION REACTOR FUEL RECOVERY

(71) Applicant: UK ATOMIC ENERGY AUTHORITY, Abingdon, Oxfordshire (GB)

(72) Inventors: Antulio TARAZONA, Abingdon (GB); Kishen LADWA, Abingdon (GB); Mohamad ABDALLAH, Abingdon (GB)

(73) Assignee: UK ATOMIC ENERGY AUTHORITY, Abingdon, Oxfordshire (GB)

(21) Appl. No.: 19/105,435

(22) PCT Filed: Aug. 4, 2023
(86) PCT No.: PCT/EP2023/071669

§ 371 Date: Feb. 21, 2025

(30) Foreign Application Priority Data
Aug. 22, 2022 (GB) 2212178.4

(51) Int. Cl. G21B 1/11; F04B 37/08; G21B 1/17

(52) U.S. Cl. CPC G21B 1/115; F04B 37/085; G21B 1/17

(57) ABSTRACT

A cryopump for recovering fuel from exhaust gas of a nuclear fusion reactor includes a chamber configured to receive the gas, a first panel arranged in the chamber and cooled to a first temperature, wherein the first temperature is greater than 20 Kelvin, a second panel arranged in the chamber and cooled to a second temperature, wherein the second temperature is in a range of 10 Kelvin to 20 Kelvin, and a valve configured to isolate the second panel from the first panel. The example cryopump allows for quicker fuel recovery for the reactor and reduces operating energy costs.

### FIELD OF THE INVENTION

The present disclosure relates generally to a technique for processing exhaust gas from a nuclear fusion reactor, such as a tokomak, to allow for rapid deuterium and tritium recovery and recycling. More specifically, the disclosure is concerned with a multistage cryopump for use in that technique.

### BACKGROUND

Currently, fusion reactors which rely on magnetic confinement, principally those designed on the principles of the tokomak, utilise a fusion fuel comprising a mix of deuterium and tritium (i.e., hydrogen isotopes). A by-product the fusion process is helium, which requires extraction from the reactor by a suitable exhaust. Of course, the helium is mixed within the reactor along with the unfused deuterium and tritium, and as such extracting helium also extracts useful reactor fuel (along with other gases present in the reactor such as Argon, Neon, and Xenon).

A cryopump is a vacuum pump whose operation involves the freezing and adsorption of gases on cold surfaces at very low temperatures. Existing magnetic confinement reactors typically utilise a cryopump cooled to around 4K to capture most, if not all, of the exhaust material from the reactor (i.e., helium, deuterium, tritium, and other impurities). For current test systems, the reactor is taken offline at the end of a test shot, and then the cryopump is regenerated in order to recover the useful fuel for later reuse in the reactor for future experiments (i.e., recycling the tritium and deuterium). This process often takes several hours. Thus typical existing reactors are considered non-continuous, and they cannot be readily adapted for continuous operation.

It will be appreciated that taking a reactor offline for several hours to recover fuel is not desirable from a commercial energy production perspective, which instead desires substantially continuous operation of a reactor. One option is to potentially ignore the need to recapture fuel by simply adding more tritium (and deuterium) into the reactor to compensate for any lost material. The problem with this approach is that tritium particularly is incredibly expensive (currently approximately thirty thousand dollars per gram) and such an approach would require a great deal of tritium (hundreds of grams). There are also safety and regulatory aspects to storing that much tritium because it is a radioactive material.

Hence it is highly desirable to develop a system which allows for efficient and continuous tritium recycling (and to a lesser extent, deuterium recycling) in order to allow the operation of the reactor in a commercial environment and to reduce the amount of tritium required.

### SUMMARY

The present invention is defined according to the independent claims. Additional features will be appreciated from the dependent claims and the description herein. Any embodiments which are described but which do not fall within the scope of the claims are to be interpreted merely as examples useful for a better understanding of the invention.

The example embodiments have been provided with a view to addressing at least some of the difficulties that are encountered with current magnetic confinement fusion reactors, whether those difficulties have been specifically mentioned above or will otherwise be appreciated from the discussion herein.

Broadly, the present disclosure relates to providing a technique to separate a tokamak's (or other reactor's) exhaust impurities from the fuel stream for rapid recycling of the fuel at high vacuum pressures. The typical recycling periods are measured in minutes rather than many hours or days for other methods. A cryogenic pump is discussed which operates to selectively capture fuel—deuterium and tritium, D & T (sometimes simply labelled DT herein), and some impurities—while allowing helium, and to a large extent protium, to be pumped out continuously during the DT cryosorption cycle. This enables rapid deuterium and tritium recycling with a minimum of impurity during the operation of the tokamak (reactor), minimises the tritium inventory, and the present techniques also beneficially lowers cryogenics power consumption. Thus, the present disclosure represents a crucial step toward achieving continuous operation of a reactor that will enable commercial energy production, overcoming the barriers to commercial operation that are inherent in existing test systems (i.e., the inability to recycle tritium on reasonable timescales).

Accordingly, in one aspect of the invention there is provided a cryopump for recovering fuel from exhaust gas of a nuclear fusion reactor. The cryopump comprises a chamber configured to receive the exhaust gas, a first panel arranged in the chamber and cooled to a first temperature greater than 20 Kelvin (more preferably in the range of 30 Kelvin to 80 Kelvin, inclusive), and a second panel arranged in the chamber and cooled to a second temperature in a range of 10 Kelvin to 20 Kelvin (inclusive). In a preferred arrangement gas is directed through the chamber past the first panel first and subsequently past the second panel, to allow impurity deposition onto the first panel and DT onto the second panel.

The cryopump comprises a first valve configured to isolate the second panel from the first panel (which results in the second panel being isolated from the reactor exhaust by dividing the chamber into two halves between the first panel and second panel). Beneficially the second panel can then be regenerated to recover the DT separately to impurities from the first panel (and indeed separately to helium processing).

In an example the cryopump comprises second and third valves configured to isolate the chamber from an inlet and outlet of the cryopump respectively. Thus the second valve isolates the second panel from the helium processing path, and the third valve isolates the first panel ready for regeneration to an impurity processing system.

In another aspect of the invention there is provided a nuclear fusion power system comprising a reactor and the aforementioned cryopump, the reactor comprising a gas exhaust suitably coupled to an inlet of the cryopump. In one example the power system comprises at least two cryopumps, the second cryopump also being coupled to the gas exhaust of the reactor.

In another aspect of the invention there is provided a method for rapid fuel recovery from a nuclear fusion power system.

### BRIEF DESCRIPTION OF THE DRAWINGS

For a better understanding of the present disclosure reference will now be made to the accompanying drawings, in which:

FIG. 1 shows a process schematic for prior art fuel recovery;

FIG. 2 shows a process schematic for fuel recovery according to the present techniques;

FIG. 3 illustrates an example cryopump during adsorption;

FIG. 4 illustrates an example cryopump during regeneration; and

FIG. 5 illustrates another example cryopump.

### DETAILED DESCRIPTION

At least some of the following example embodiments provide an improved technique for recycling tritium (and deuterium) for a fusion reactor. Other advantages and improvements may also be apparent from the discussed herein.

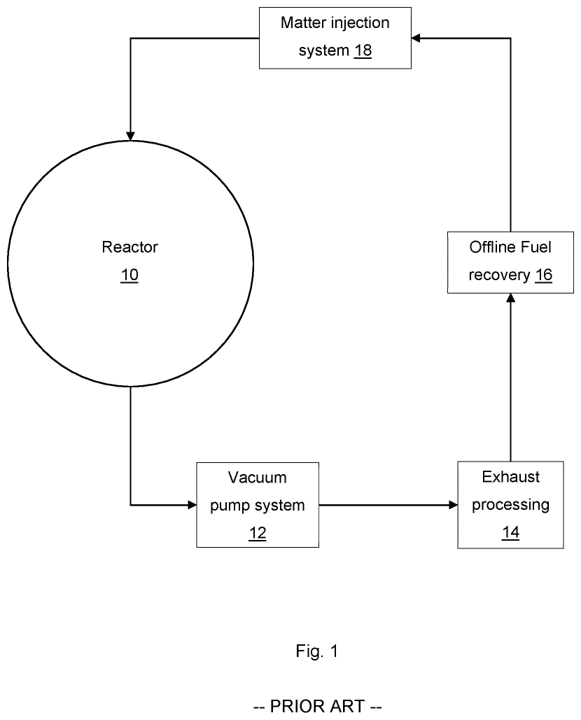

FIG. 1 shows a simplified process schematic of a prior art fuel recovery system. Here, a reactor 10 utilises deuterium and tritium as fusion fuel to generate energy and, inter alia, helium by-product. A vacuum pump system 12 extracts gas from the reactor 10 via an exhaust. The pump system 12 includes a cryopump comprising adsorb panels cooled to around 4 K (degrees Kelvin)—more specifically, typically in the range of 4.2-4.5K. This temperature is chosen because it allows the cryopump to adsorb helium, tritium, deuterium, and other impurities from the exhaust gas. While the reactor 10 is offline, the cryopump adsorb panels are regenerated (i.e., heated up) so that exhaust processing system 14 can separate the material adsorbed onto the cryopump panel. Thus, the exhaust processing allows for fuel recovery 16 due to the separation of the deuterium and tritium from the other materials captured from the exhaust. The fuel that is recovered will typically be stored and then sometime later used by matter injection system 18 to feed the fuel back into the reactor 10. The cycle is repeated next time the reactor is deactivated.

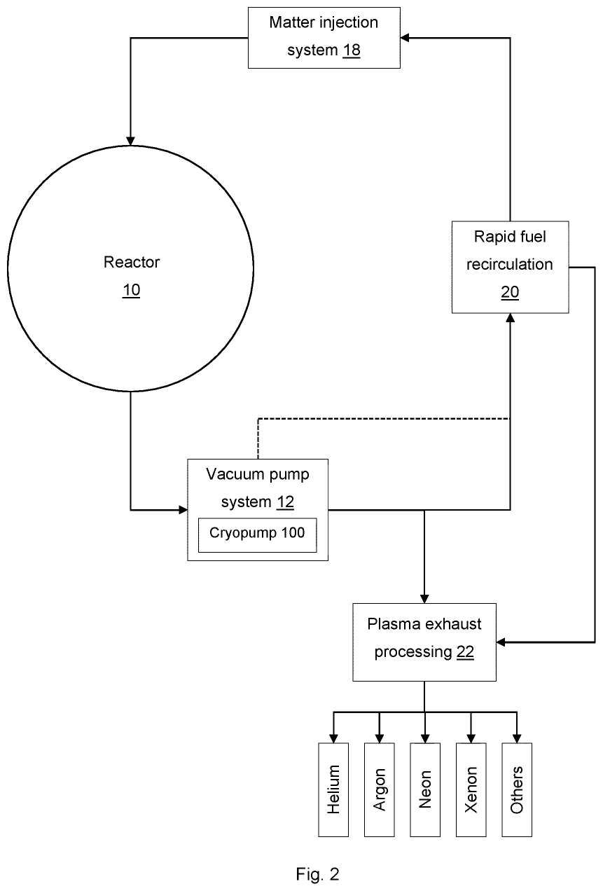

FIG. 2 shows a schematic for an improved technique for deuterium/tritium fuel recovery for continuous reactor operation. The technique is described with reference to exhaust gas, but it will be appreciated that the technique may be applied to any suitable outflow of gas from the reactor 10. Also, the following will refer to deuterium and tritium in combination due to that being the current standard fuel mix for fusion reactors, although it will be appreciated that the present techniques could apply to other fuel mixtures comprising at least one of deuterium and tritium (and principally it is tritium which is generally the more important of the two).

Similar to FIG. 1, exhaust gas may be extracted from the reactor via a suitable vacuum pumping system 12. Here however the vacuum system 12 comprises an improved cryopump 100, and other vacuum pumps to exhaust at different pressures up to atmospheric pressures (not included in FIG. 2). In general, the improved cryopump 100 is arranged to capture deuterium and tritium from the exhaust gas separately from other impurities and helium. The captured deuterium and, more importantly, tritium, is then directed from the cryopump 100 to the matter injection system 18 without the need for any extraneous processing. Thus, fuel may be rapidly recovered (box 20) and reinjected into the reactor 10. Here, “rapid” means on the order of minutes, or tens of minutes, in contrast to the hours long timescales that fuel is currently recovered over. Beneficially, a reactor 10 employing the improved cryopump would only require a low tritium inventory while still allowing for continuous operation of the reactor 10. If existing test systems were used for commercial energy production, then the required tritium inventory would be on the order of hundreds of grams to operate in a (near) continuous fashion; by contrast, the present techniques are estimated to only require a few grams of Tritium inventory (e.g., 3 to 4 grams).

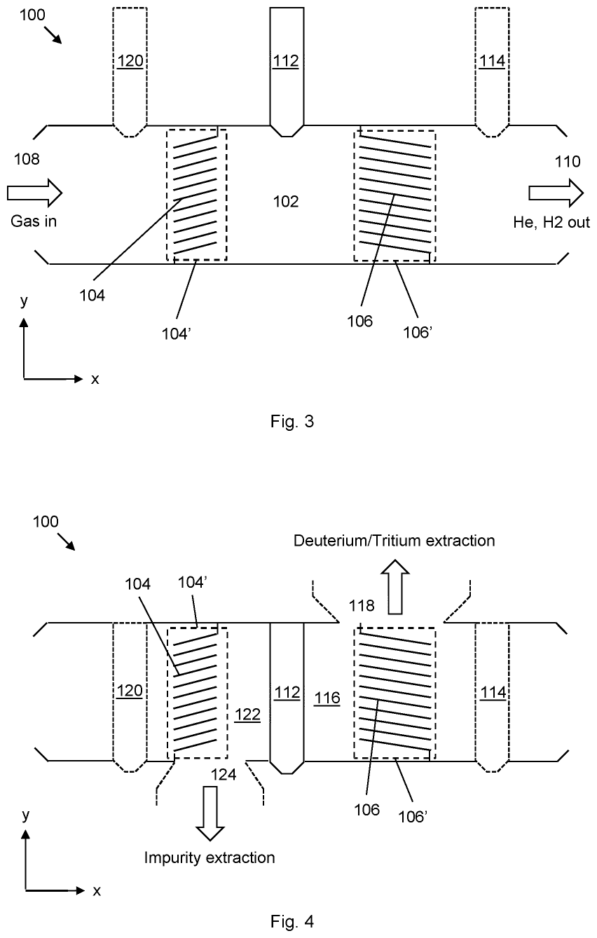

FIGS. 3 and 4 show schematic diagrams of an example cryopump 100. The cryopump 100 comprises a chamber 102 into which is received exhaust gas from the reactor 10, and a first panel 104 and second panel 106 both arranged (i.e., disposed) in the chamber 102. As demonstrated, the first panel 104 and second panel 106 are each preferably one of an array of panels that are collocated within the chamber 102 (i.e., at a similar point on an axis of the cryopump 100, here an “X” axis defined as being substantially parallel to gas inflow to the cryopump 100). That is, the cryopump 100 may comprise a first array of panels 104′ and a second array of panels 106′, the first array of panels 104′ comprising the first panel 104 and second array of panels 106′ comprising the second panel 106. The first panel(s) 104 and second panel(s) 106 are arranged separated in the chamber 102.

The first panel(s) 104 is/are cooled to a first temperature while the second panel(s) 106 is/are cooled to a second temperature. The first and second temperatures are different so as to provide adsorption of different materials onto the first/second panel(s) 104, 106; thus the example cryopump 100 may be considered a multistage cryopump (specifically a two stage pump). The first panel(s) 104 are configured to capture impurities from the exhaust gas, while the second panel(s) 106 are configured to capture unspent fuel (i.e., DT) from the exhaust gas. To promote adsorption of material, some (or all) of the panels 104, 106 may be coated in activated carbon. Other coatings which encourage adsorption may be applied instead. It will be appreciated that where an array of panels is utilised, cooling an array to the first or second temperature means setting the target temperature for that array while allowing for some variation in the array (within a target range).

The first panel(s) 104 is/are cooled to a temperature greater than 20 K (degrees Kelvin). Such temperatures allow for the capture of undesirable impurities from the exhaust gas, but importantly do not generally capture deuterium and tritium. Preferably the first panel(s) 104 is/are cooled to between 30 K and 80 K (inclusive).

The second panel(s) 106 is/are cooled to a temperature between 10 K and 20 K (inclusive); more broadly, the second panel(s) 106 is/are cooled to a lower temperature than the first panel(s) 104. Cooling the second panel(s) 106 to between 10 K and 20 K allows fuel (i.e., deuterium and tritium) to adsorb onto the second panel.

It will be appreciated that the described panel operating temperatures are all far in excess of the typical 4 K at which current systems operate cryopumps, allowing for significant energy gains in terms of efficiency compared to such systems.

Gas inflow to the cryopump 100, and chamber 102, is via an inlet 108. In a reactor system, the inlet 108 is therefore suitably coupled to the reactor exhaust (e.g., by components of the vacuum system 12). The gas flows through the chamber 102 to an outflow 110. As the gas flows through the chamber 102 it flows first past the first panel(s) 104 and subsequently past the second panel(s) 106. This arrangement reduces the amount of impurities deposited on the second panel(s) 106 thereby reducing a need for subsequent purification of the deuterium/tritium from the second panel(s) 106; of course, in principle, the panels could be arranged the other way round in the chamber 102. Suitably, it may be considered that during cryosorption of the fuel and impurities from the exhaust gas, the adsorption panels are connected in parallel.

The example cryopump 100 is not arranged to capture helium nor molecular protium. Doing so would require a cryopump panel (or array of panels) set to substantially 4 K. In principle, such a panel/array of panels could be arranged in the chamber 102 to provide an additional stage of adsorption. Such an arrangement is not preferred, however, due to the increased energy requirements of cooling a set of panels to capture helium and/or protium. Instead, helium and/or protium is pumped out of the cryopump via the outlet 110. Put another way, the inlet 108 and outlet 110 are in fluid communication, via the chamber 102, such that gas may flow through the cryopump 100 past each of the panels 104, 106. The helium, molecular protium and other impurities (e.g., other gases) are pumped to a plasma exhaust processing system 22 (FIG. 2).

In a preferred example, the cryopump 100 comprises a first valve 112 configured to isolate the second panel(s) 106 from the first panel(s) 104. That is, the first valve 112 comprises an open position (FIG. 3) in which gas flows through the chamber 102 freely from the inlet 108 to outlet 110 past the first and second panels 104, 106, and a closed position (FIG. 4) in which gas is prevented from flowing through the chamber 102 past the second panel(s) 106 and out of the cryopump 100.

When the second panel(s) 106 is/are suitably isolated from the gas exhaust (i.e., while the first valve 112 is closed), the second panel(s) 106 may be regenerated in order to release the captured fuel (deuterium and tritium). Regenerating the second panel(s) 106 comprises deactivating the cooling of the second panels to the target temperature, and may also comprise active heating of the panel(s) 106 in order to heat the panels quicker and speed up the regeneration process.

In an example, the regenerated fuel may then be readily routed to the matter injection system 18 and recycled to the reactor 10 via a route which involves the outlet 110—and so is at least partly shared by vacuum channels by which the helium was previously routed and extracted—but without going through the plasma exhaust processing system 22. That is, general plasma processing 22 may be isolated from the cryopump 100, and suitable gas channels to the matter injection system 18 opened, when the first valve 112 is closed. Such an arrangement is preferred due to the simplicity of design of the example cryopump 100.

Thus a reactor system comprising the example cryopump 100 may be made more efficient by removing the need for additional material processing to separate fuel from helium and other impurities, and reduces the need for large tritium inventory by routing the tritium quickly back into the reactor 10.

Also while the valve 112 is closed, the first panel(s) 104 may also be regenerated. That is, cooling to the first panel(s) 104 may be deactivated—and optionally the first panel(2) 104 actively heated—while the second panel(s) 106 are being regenerated on the other side of the closed valve 112. In other words, panel regeneration may be achieved in parallel—in contrast to the series cryosorption—which allows for more efficient operation of the cryopump and related systems.

In particular, impurities regenerated from the first panel(s) 104 may be suitably routed from the cryopump to plasma processing system 22, separate to the any route the fuel takes (by, e.g., a suitable valve/outlet 122, FIG. 4). Alternatively, by raising the temperature of the second panel(s) 106 to above 80K during regeneration, the first valve 112 may be opened (after a predetermined time period, or after measuring a desired amount of fuel recovery from the second panel(s) 106) and impurities released from the first panel(s) 104 released from the cryopump 100 via the outlet 110 (and the burden of directing the impurities to the relevant location placed downstream of the cryopump).

After regeneration of the first and second panel(s) 104, 106, it will be appreciated that the panels may be re-cooled to the appropriate target temperatures, the first valve 112 re-opened, and the process of fuel recovery restarted.

In another example, the cryopump 100 comprises a second valve 114 configured to isolate the second panel(s) 106 (and more generally the chamber 102) from the outlet 110; it will also be appreciated that the second valve 114 may be suitably configured as part of the outlet 110. Put another way, the second valve 114 isolates the chamber 102 from the helium gas outflow system 22.

More specifically, the second valve 114 comprises an open position (FIG. 3) in which gas flows through the chamber 102 from the inlet 108 to outlet 110 past the first and second panels 104, 106, and a closed position (FIG. 4) which seals the second panels(s) 104 from the outlet 110. Thus, the combination of the first valve 112 and second valve 114 create a sub-chamber 116 within the chamber 102 which is isolated from the rest of the cryopump 100. Put another way, the second panel(s) 106 is/are isolated from the chamber 102.

In this arrangement the sub-chamber 116 comprising the second panel(s) 106 may be suitably coupled to a dedicated fuel recovery route via e.g., a second outlet 118 which is suitably opened (by e.g., a suitable valve) when the first and second valves 112, 114 are closed and the second panel(s) are regenerating (FIG. 4), but which is otherwise suitably closed when the cryopump 100 is being used to recover fuel.

The cryopump 100 may also comprise a third valve 120 configured to isolate the first panel(s) 104 (and more generally the chamber 102) from the inlet 108; it will also be appreciated that the third valve 120 may be suitably configured as part of the inlet 108. Put another way, the third valve 120 isolates the chamber 102 (and more generally the cryopump as a whole) from the reactor 10.

More specifically, the third valve 120 comprises an open position (FIG. 3) in which gas flows through the chamber 102 from the inlet 108 to outlet 110 past the first and second panels 104, 106, and a closed position (FIG. 4) which seals the cryopump 100 from receiving further exhaust gas. Thus, the combination of the first valve 112 and third valve 120 create a sub-chamber 122 within the chamber 102 which is isolated from the rest of the cryopump 100. Put another way, the first panel(s) 104 is/are isolated from further gas flow.

The sub-chamber 122 comprising the first panel(s) 104 may be suitably coupled to a dedicated impurity processing system via e.g., a third outlet 124 which is suitably opened (by e.g., a suitable valve) when the first valve 112 is closed (and optionally when the second valve 114 is also closed and/or the third valve 120 is closed, if such valves are present), but is otherwise closed during the cryosorption. In this way the first panel(s) 104 may be regenerated to release previously captured impurities away from the cryopump 100 while the reactor 10 is in operation and while the fuel is also being regenerated via a separate system.

In another example, the first panel(s) 104 may be regenerated (when saturated) via a staged deactivation of the cryopump, in which the first valve 112 is closed, the second panel(s) 106 are then regenerated to recover fuel, the first valve 112 opened, and then the first panel(s) 104 regenerated to extract impurities via a suitable system coupled to the outlet 110.

To aid in continuous operation of a fusion reactor 10, each of the valves 112, 114, 120 (if present) may be suitably controlled on a timer, so that they are actuated at predetermined intervals. For example, the first valve 112 may be configured to remain open for at least two to three hours of reactor operation, and then automatically controlled to close for 20 minutes to allow regeneration of fuel, before opening and allowing the process to repeat. Alternatively, diagnostic devices may be arranged to monitor the saturation levels of the first and second panels 104, 106, and regeneration of the panels initiated (starting with closing the relevant valves) based on the determined saturation level.

It may also be desirable to provide at least one further example cryopump as part of the vacuum system 12. That is a second cryopump, configured according to the above description, may also be coupled to the gas exhaust from the reactor 10. Thus, when the first cryopump is isolated from the gas exhaust in order to regenerate fuel (and/or impurities, as required) the second cryopump may be used to continue processing the exhaust gas.

More specifically, when the second panel(s) 106 from the first cryopump 100 is isolated from the exhaust gas (i.e., isolated from the reactor)-so that the second panel(s) 106 may be regenerated to recover fuel—the reactor exhaust gas may be directed to a second cryopump 100 comprising a third (array of) panel(s) 104 and a fourth (array of) panel(s) 106, the third panel(s) being configured to capture impurities and the fourth panel(s) configured to capture fuel.

Later, fuel may be regenerated from this second cryopump, in the same manner as described above, while the first cryopump is reactivated for fuel capture.

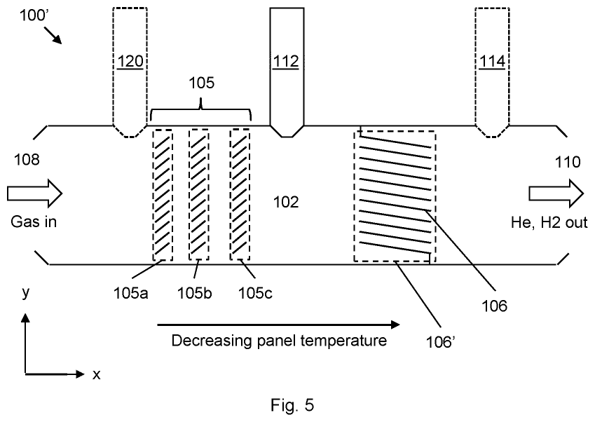

FIG. 5 shows another example cryopump 100′, which builds upon the previous techniques. Here the example cryopump 100′ is provided with additional panels/sets of panels to increase the capture of impurities and non-helium/protium gas—for example, the other reactor gases such as Xenon, Argon, and Neon—with the aim of increasing the purity of the deuterium and tritium adsorbed to the second panel(s) 106. In such an example, each (set of) panel(s) provided in the cryopump 100 represents an additional stage of adsorption. In particular, each (set of) panel(s) may be suitably set to a different temperature range; preferably, the temperature of each (set of) panel(s) decreases from the first panel(s) 104 in the cryopump to the second (last) panel(s) 106; i.e., the panels in the cryopump have a decreasing temperature gradient. The more panels that are provided, the sharper the separation of the deuterium and tritium from other impurities; that is, the more stages of adsorption that is provided, the greater the purity of the deuterium and tritium on the second panel(s) 106.

More specifically, the example cryopump 100′ comprises a plurality of first panels 105, or a plurality of arrays/sets of first panels, here three (sets of) panels 105a, b & c spaced apart from each other within the chamber 102 (i.e., separated along an axis of the cryopump 100′, here the X axis). Each of the plurality of first panels 105 is cooled to a temperature greater than 20 K; preferably between 30 K and 80 K (inclusive). Each (array of) panel(s) is cooled to a different temperature, and preferably the temperature of each of the plurality of first panels 105 decreases the further from the inlet 108 and the closer to the second panel 106 the panel (array) 105a, b, c is. For example, the first panel (array) a of the plurality may be set to a temperate range of 70 K to 80 K, the second panel (array) 105b may be set to a temperature range of 50 K to 60 K, and the third panel (array) 105c may be set to a temperature range of 30 K to 40 K. In general, it will be appreciated that any number of panel(s) may be provided in the first plurality of panels 105, provided each panel (array) is set to a different temperature. Moreover, as shown, the first plurality of panels 105 is arranged in the chamber 102 before the first valve 112, so that the first plurality of panels 105 may be suitably isolated from the second panel(s) 106.

It should also be appreciated that, in this example, the operation of the second panel(s) 106, and the remainder of the cryopump 100′, is substantially the same as already described above in relation to the example cryopump 100.

In summary, exemplary embodiments of a multistage cryopump which facilitates fuel recovery from fusion reactor exhaust have been described. The described exemplary embodiments provide for an improved technique that facilitates continuous operation of the reactor: an important consideration for commercial energy production. Moreover, the exemplary embodiments reduce the energy requirements for fuel recycling compared to typical techniques.

The example cryopump and ancillary systems may be manufactured industrially. An industrial application of the example embodiments will be clear from the discussion herein. Additionally, the described exemplary embodiments are convenient to manufacture and straightforward to use.

Although preferred embodiment(s) of the present invention have been shown and described, it will be appreciated by those skilled in the art that changes may be made without departing from the scope of the invention as defined in the claims.

Attention is directed to all papers and documents which are filed concurrently with or previous to this specification in connection with this application and which are open to public inspection with this specification, and the contents of all such papers and documents are incorporated herein by reference.

All of the features disclosed in this specification, and/or all of the steps of any method or process so disclosed, may be combined in any combination, except combinations where at least some of such features and/or steps are mutually exclusive.

Each feature disclosed in this specification may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification, or to any novel one, or any novel combination, of the steps of any method or process so disclosed.

1. A cryopump for recovering fuel from exhaust gas of a nuclear fusion reactor, comprising:
a chamber configured to receive the gas;
a first panel arranged in the chamber and cooled to a first temperature, wherein the first temperature is greater than 20 Kelvin;
a second panel arranged in the chamber and cooled to a second temperature, wherein the second temperature is in a range of 10 Kelvin to 20 Kelvin, inclusive; and
a first valve configured to isolate the second panel from the first panel.

2. The cryopump of claim 1, wherein the first temperature is in the range of 30 Kelvin to 80 Kelvin, inclusive.

3. The cryopump of claim 1, wherein the cryopump is configured to direct gas through the chamber past the first panel first and subsequently past the second panel.

4. The cryopump of claim 1, wherein the first panel is one panel of an array of panels cooled to the first temperature.

5. The cryopump of claim 1, wherein the second panel is one panel of an array of panels cooled to the second temperature.

6. The cryopump of claim 1, wherein the first panel and second panel, and where appropriate the first and second arrays of panels, are coated in activated carbon.

7. The cryopump of claim 1, further comprising at least one additional panel, or array of panels, spaced apart from the first panel and cooled to a temperature greater than 20 Kelvin which is different to the first temperature.

8. The cryopump of claim 7, wherein the first panel and at least one additional panel are arranged to provide a decreasing temperature gradient towards the second panel.

9. The cryopump of claim 1, further comprising a second valve configured to isolate the chamber from an outlet from the cryopump, and wherein the second panel is arranged in the chamber between the first valve and the second valve.

10. The cryopump of claim 9, further comprising a third valve configured to isolate the chamber from an inlet to the cryopump, and wherein the first panel is arranged in the chamber between the first valve and the third valve.

11. The cryopump of claim 1, wherein the first valve and, when present, the second and third valves, are configured to actuate at predetermined intervals.

12. A nuclear fusion power system comprising:
a reactor comprising a gas exhaust coupled to a cryopump;
the cryopump comprising:
an inlet coupled to the gas exhaust to receive gas from the fusion reactor;
an outlet in fluid communication with the inlet via a chamber, the outlet providing an outflow for the gas from the cryopump;
a first panel arranged in the chamber and cooled to a first temperature, wherein the first temperature is greater than 20 Kelvin;
a second panel arranged in the chamber and cooled to a second temperature, wherein the second temperature is in a range of 10 Kelvin to 20 Kelvin, inclusive; and
a first valve configured to isolate the second panel from the first panel.

13. The fusion power system of claim 12, wherein the cryopump is a first cryopump of at least two cryopumps arranged in the system, and wherein an inlet of a second cryopump of the at least two cryopumps is coupled to the gas exhaust of the reactor.

14. The fusion power system of claim 12, wherein the cryopump is configured to satisfy at least one of the following features:
the first temperature is in the range of 30 Kelvin to 80 Kelvin, inclusive;
the cryopump is configured to direct gas through the chamber past the first panel first and subsequently past the second panel;
the first panel is one panel of an array of panels cooled to the first temperature;
the second panel is one panel of an array of panels cooled to the second temperature;
the first panel and second panel are coated in activated carbon;
the cryopump further comprises at least one additional panel spaced apart from the first panel and cooled to a temperature greater than 20 Kelvin which is different to the first temperature, and optionally the first panel and at least one additional panel are arranged to provide a decreasing temperature gradient towards the second panel;
the cryopump further comprises a second valve configured to isolate the chamber from an outlet from the cryopump, and wherein the second panel is arranged in the chamber between the first valve and the second valve, and optionally further comprises a third valve configured to isolate the chamber from an inlet to the cryopump, and wherein the first panel is arranged in the chamber between the first valve and the third valve; and
the first valve and, when present, the second and third valves, are configured to actuate at predetermined intervals.

15. A method for rapid fuel recovery from a nuclear fusion reactor, the fuel comprising at least one of deuterium and tritium, the method comprising:
directing exhaust gas from the reactor past a first cryopump panel cooled to a first temperature greater than 20 Kelvin to adsorb impurities from the exhaust gas onto the first panel;
subsequently directing the exhaust gas past a second cryopump panel cooled to a second temperature between 10 Kelvin to 20 Kelvin, inclusive, to adsorb the at least one of deuterium and tritium onto the second panel; and
isolating the second panel from the exhaust gas of the reactor by a first valve, and regenerating the second panel to recover the at least one of deuterium and tritium.

16. The method of claim 15, wherein regenerating the second panel to recover the at least one of deuterium and tritium further comprises pumping the recovered at least one of deuterium and tritium back into the fusion reactor.

17. The method of claim 15, wherein when the second panel is isolated from the exhaust gas, the method further comprises:
directing exhaust gas from the reactor past a third cryopump panel cooled to a first temperature greater than 20 Kelvin to deposit impurities from the exhaust gas onto the third panel; and
subsequently directing the exhaust gas past a fourth cryopump panel cooled to a second temperature between 10 Kelvin to 20 Kelvin, inclusive, to deposit the at least one of deuterium and tritium onto the fourth panel.
